(19) United States
(12) Patent Application Publication
(10) Pub. No.: US 2026/0109375 A1
(43) Pub. Date: Apr. 23, 2026

(54) MODELING AGENT DRIVING BEHAVIOR

(71) Applicant: Waymo LLC, Mountain View, CA (US)

(72) Inventor: Johan Engstrom, Los Gatos, CA (US)

(21) Appl. No.: 19/231,163

(22) Filed: Jun. 6, 2025

Related U.S. Application Data
(60) Provisional application No. 63/657,623, filed on Jun. 7, 2024.
(60) Provisional application No. 63/662,321, filed on Jun. 20, 2024.

(51) Int. Cl. B60W 60/00; G06N 5/04; G06V 20/58

(52) U.S. Cl. CPC B60W 60/0011; G06N 5/04; G06V 20/58

(57) ABSTRACT

Methods, systems, and apparatus, including computer programs encoded on computer storage media, for modeling human driving behavior. One of the methods includes continually computing, at each time step, a respective observation deviation value for a current driving policy of an agent. An accumulated observation deviation value is computed including accumulating observation deviation values computed for each of a plurality of time steps. If an accumulated observation deviation value satisfies a threshold, a different policy is selected for the agent to execute after the accumulated observation deviation value satisfies the threshold.

### CROSS-REFERENCE TO RELATED APPLICATIONS

This application incorporates by reference the following U.S. patent applications: U.S. application Ser. No. 18/614,428, filed Mar. 22, 2024, and entitled “ASSESSING DRIVING PLANS FOR AUTONOMOUS VEHICLES”; U.S. Application No. 63/454,012, filed Mar. 22, 2023, and entitled “ASSESSING DRIVING PLANS FOR AUTONOMOUS VEHICLES”; U.S. application Ser. No. 18/233,696, filed Aug. 14, 2023, and entitled “COMPUTING AGENT RESPONSE TIMES IN TRAFFIC SCENARIOS,”; U.S. Application No. 63/397,771, filed Aug. 12, 2022, and entitled COMPUTING AGENT RESPONSE TIMES IN TRAFFIC SCENARIOS″; U.S. Application No. 63/657,623, filed Jun. 7, 2024, and entitled “MODELING AGENT DRIVING BEHAVIOR”; and U.S. Application No. 63/662,321, filed Jun. 20, 2024, and entitled “MODELING AGENT DRIVING BEHAVIOR.”

### BACKGROUND

This specification relates to autonomous vehicles and enhanced techniques to realistically model the driving behavior of agents in traffic environments.

Autonomous vehicles include self-driving cars (including buses, trucks, etc.), boats, and aircraft. Autonomous vehicles use a variety of on-board sensors and computer systems to detect nearby objects and use such detections to make control and navigation decisions.

Fully autonomous driving by an autonomous vehicle (AV) or a self-driving car (SDC) has been a difficult and complex technical problem to solve. Part of the complexity stems from the fact that simply knowing current traffic laws, reliably detecting other agents (e.g., vehicles, pedestrians, cyclists, etc.) and being able to control the vehicle to high degrees of precision are still often not enough to achieve fully autonomous driving. This is because the actions of other agents also need to be anticipated, which can be a much harder problem than the mere detection of static obstacles. For example, if a cyclist is detected approaching an intersection, whether or not an AV should stop at the intersection, or keep going, largely depends on what the cyclist is expected to do and what the cyclist is expecting the AV to do, which is information that is not possible to observe directly.

A related complexity is modeling the decision making of agents in traffic conflict scenarios. In this specification, a traffic conflict scenario is a situation in which two or more vehicles get closer together in time and space to the extent that a crash is imminent if their movements remain unchanged. This is difficult to model in naturally occurring traffic conflicts because it is often unclear what defines the start of a stimulus or how long it will take a driver to react to a stimulus. For example, if a system wants to model the reactions of a driver observing another vehicle approaching and then running a stop sign, the onset of a stimulus is not when the vehicle is first observed because there may be nothing amiss to react to at that point in time. Likewise, the vehicle actually running through the stop sign is too late of a time to be the onset of a stimulus because a human driver will notice something is wrong at some point in time before the car crosses the intersection, particularly when the vehicle fails to start slowing down. Moreover, even when a different plan of action is apparent, it is a difficult problem to realistically model how long it would take a human driver to react to particular stimuli.

### SUMMARY

This specification describes techniques for a computer system to model the driving behaviors of agents in a driving environment using aspects of active inference modeling. In particular, the system can compute model agents reacting to particular scenarios by accumulating observation deviation values of a current driving policy from a preferred state given a set of observations. This arrangement prevents the agent from being able to select a new driving policy until the accumulated observation deviation values have reached a threshold. This approach provides for more realistic modeling of human driving behavior, in part because it prevents the modeled agent from being able to instantaneously switch to a new policy, which no human can do.

In this specification, an observation deviation value is a metric that measures a difference between a preferred observation of an agent in a driving environment and an actual observation in the driving environment. For example, the preferred observation can be a goal state of a particular driving policy, and the actual observation can be based on current sensor data. As one example, a goal state can specify that an agent should remain 100 feet behind another vehicle. If the other vehicle brakes suddenly, the observed state will begin to differ from the goal state. The observation deviation value can be represented using any appropriate form and can be positive or negative depending on the goals of the system. For example, an observation deviation value can be positive so that larger deviations are associated with larger values, or it can be negative so that less desirable situations have a lower value.

One example of an observation deviation value is a pragmatic value used in active inference modeling. Active inference is a modeling framework that models agent behaviors as intending to minimize surprising events, or equivalently, to maximize the evidence of the agent's own world model. To do so in a computationally tractable way, active interference models seek to minimize variational free energy, which represents an upper bound on potential surprising events. For driver behavior modeling, active inference models seek to model the choices of human drivers as selecting a potential course of action based on its expected free energy (EFE), which can be partitioned into a pragmatic value and an epistemic value.

The pragmatic value represents goal-seeking behavior, and the epistemic value represents information-seeking (uncertainty-resolving) behavior. These values can be mapped conceptually to progress vs. caution or exploitation vs. exploration, respectively. Thus, when the examples in this specification refer to pragmatic values being computed or accumulated, the same techniques can be used for any other type of observation deviation value.

These techniques provide a framework for measuring and modeling response times in natural driving environments either online as part of a deployed self-driving system or offline in simulation for analysis and benchmarking of self-driving system performance. In this specification, online driving contexts refer to live contexts in which an AV planning system is deployed in real traffic scenarios and offline driving contexts refer to either retrospective evaluation of deployed planning systems or assessment of planning systems in simulations.

In this specification, an agent can be any appropriate entity in a real or simulated driving environment capable of moving independently. Thus, an agent can be an autonomous or semi-autonomous vehicle (AV). An agent can also be any other motorized vehicle-including passenger cars, minivans, pickup trucks or larger trucks-cyclists, pedestrians, and animals, to name just a few examples. In this specification, a hypothesis is a prediction about the likelihood of another entity executing a particular behavior in a traffic scenario from the point of view of the agent.

Particular embodiments of the subject matter described in this specification can be implemented to realize one or more of the following advantages.

The techniques described herein can improve the performance of modeling agent decision-making in real-world driving scenarios and in simulation. For example, modeling agent decision-making by instantaneously selecting a driving policy based on an observation can result in unrealistic models of the agent decision-making because human drivers in real-world scenarios do not instantaneously change driving policies. Instead, human drivers in real-world scenarios may change driving policies only after making multiple observations that indicate that a current driving policy ought to be changed. The techniques described herein involve selecting a different policy, e.g., from a current driving policy, in response to determining that an accumulated observation deviation value satisfies a threshold. The accumulated observation deviation value includes accumulated observation deviation values computed for a plurality of time steps. In this way, a different policy is selected only after a deviation from a preferred state occurs at least a threshold number of times. Modeling agent decision-making in this way causes the model to more closely resemble human driving behavior in real-world scenarios by causing the model to account for the fact that human drivers cannot instantaneously react to surprising events and are unlikely to change driving policies based on a small number of observations. In simulation scenarios, modeling human drivers using accumulated observation deviation values results in driving behaviors that closely match real-world observations.

The techniques disclosed herein can improve the performance of driving behavior models by increasing a likelihood that the modeled behavior includes driving policies that reduce the chances of surprising events occurring for an agent following the policies. For example, it can be difficult to predict actions of other agents in a driving environment. This uncertainty with respect to the actions of other agents can result in selecting driving policies that lead to the occurrence of unpredicted events, e.g., because of unpredicted actions taken by other agents.

The techniques disclosed herein involve computing observation deviation values, which are used in determining to change a driving policy, as components of the expected free energy value of an active inference modeling framework. For example, a system employing the techniques disclosed herein can determine a control policy for the driving of an agent by selecting a trajectory, which the control policy is to follow, as a trajectory that has the lowest expected free energy from among a set of trajectories. The expected free energy is computed based on observation deviation values, e.g., including a pragmatic value, such that minimizing the expected free energy minimizes a likelihood of the occurrence of surprising events under the control policy associated with the expected free energy. The expected free energy is computed based on an epistemic value that represents a potential reduction in uncertainty for a current driving policy. In this way, driving policies selected according to the techniques disclosed herein can be less likely to include occurrences of unpredicted events.

The techniques disclosed herein can increase a likelihood of modeling driving behavior realistically by using a looming value in selecting a driving policy under the model. Driving behavior models that fail to account for the limits of human perception as well as its effect on the time required for a human driver to respond to a traffic conflict can model driving behavior in a way that does not reflect realistic actions of an agent. The techniques disclosed herein involve using a looming value to select a driving policy. For example, a system employing the described techniques can continually compute a looming value relative to another road user and select a new driving policy after the looming value satisfies a threshold. A looming value can represent a visual angle subtended by an object from an observer's point of view. The satisfaction of the looming value of the threshold in a given driving scenario can increase a likelihood that a driving agent in the given scenario perceives the other road user to which the looming value corresponds. Because a driving agent in a real-world scenario would not change a driving policy based on actions of another road user until the driving agent has perceived the other road user, selecting a new driving policy after the looming value satisfies the threshold can increase a likelihood that the selection of the new driving policy is more realistic.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTIONS OF THE DRAWINGS

FIG. 1 is a diagram of an example AV system that uses an active inference model.

FIG. 2 depicts an example traffic scenario of an agent and another entity vehicle approaching an intersection in an interaction that illustrates the main challenges inherent to measuring and modeling agent driving behavior in real-life scenarios.

FIG. 3 is a diagram of a framework that provides for modeling agent decisions in real-world scenarios.

FIG. 4 is a flow diagram of an example process for selecting a driving policy for an agent to execute.

Like reference numbers and designations in the various drawings indicate like elements.

### DETAILED DESCRIPTION

This specification describes techniques for modeling agent driving behavior for traffic scenarios. This information can be used for a variety of purposes. As one example, an on-board AV planning system can use this information in an online driving context to anticipate the actions of other entities and select a particular driving control policy from a library of driving control policies once the actions of other agents have been predicted. As another example, the information can be used offline to evaluate trip logs of AV travels in order to determine how well the AV planning system handled and anticipated the actions of other agents in certain traffic scenarios. As another example, the techniques described in this specification can be used to evaluate new control policies either as deployed in the real-world or in a simulation that provides a greater variety of traffic conflict scenarios than the AV would have experienced in the real-world.

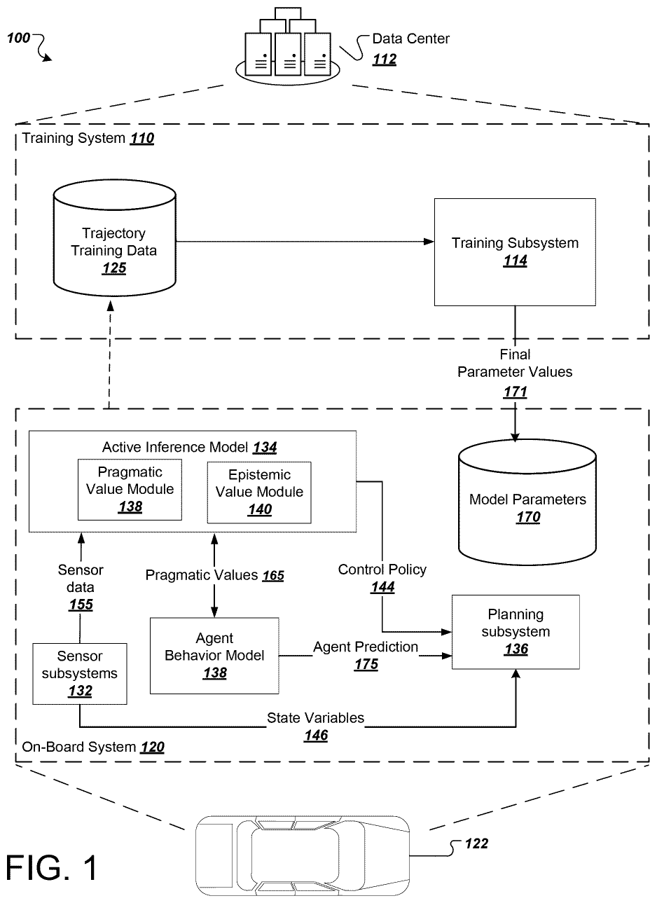

FIG. 1 is a diagram of an example AV system 100 that uses an active inference model 134. The system 100 includes a training system 110 and an on-board system 120 that can use an agent prediction 175 and the active inference model 134 to inform driving decisions.

The active inference model 134 can be used to model the pragmatic value and epistemic value of control policies for either the vehicle itself 122, other agents in the environment, or both. In this example the active inference model 134 is used to select a candidate control policy 144 as well as to compute the pragmatic values 165 of predicted behavior of other agents in the driving environment.

An agent behavior model 138 uses the pragmatic values 165 to compute a prediction of a likely course of action for another agent in the driving environment. As described below, the prediction is based on an accumulated pragmatic value over a particular time window.

The on-board system 120 is physically located on-board a vehicle 122 and is used in online driving contexts in which the AV is operating in real traffic scenarios. Being on-board the vehicle 122 means that the on-board system 120 includes components that travel along with the vehicle 122, e.g., power supplies, computing hardware, and sensors. The vehicle 122 in FIG. 1 is illustrated as an automobile, but the on-board system 120 can be located on-board any appropriate vehicle type. The vehicle 122 can be a fully autonomous vehicle that uses predictions about nearby objects in the surrounding environment to inform fully autonomous driving decisions. The vehicle 122 can also be a semi-autonomous vehicle that uses predictions about nearby objects in the surrounding environment to aid a human driver. For example, the vehicle 122 can rely on the planning subsystem 136 to autonomously begin an evasive maneuver if surprising evidence starts accumulating beyond a safety threshold.

The on-board system 120 includes one or more sensor subsystems 132. The sensor subsystems can include a combination of components that receive reflections from the environment, e.g., lidar systems that detect reflections of laser light, radar systems that detect reflections of radio waves, camera systems that detect reflections of visible light, and audio sensor systems that record sounds from the environment, to name just a few examples.

The input sensor data 155 can indicate a distance, a direction, and an intensity of reflected energy for one or more objects in the environment. Each sensor can transmit one or more pulses, e.g., of electromagnetic radiation, in a particular direction and can measure the intensity of any reflections as well as the time that the reflection was received. A distance can be computed by determining how long it took between a pulse and its corresponding reflection. Each sensor can continually sweep a particular space in angle, azimuth, or both. Sweeping in azimuth, for example, can allow a sensor to detect multiple objects along a same line of sight.

The input sensor data 155 can include data from one sensor or multiple sensors at multiple locations surrounding the vehicle 122. The input sensor data 155 thus provides a representation of the surrounding environment of the vehicle, which can include data representing the presence of objects, as well as data about the objects, such as a type of an object, a speed, a heading, a position, an acceleration, to name just a few examples.

The sensor subsystems 132 can provide input sensor data 155 to an active inference model 134. The active inference model 134 uses sensor observations and vehicle state in order to generate a candidate control policy 144. As a particular example, the system can use the active inference model 134 to determine a control policy that follows an optimized trajectory. To do so, the system can estimate the free energy associated with trajectories within a defined planning time horizon. At each timestep, the system can select the trajectory that has the lowest expected free energy (EFE). As an example, the expected free energy for a trajectory can be defined as a negative sum of a pragmatic value and an epistemic value:

$$EFE = G ( π ) = - {\underbrace{{𝔼}_{Q ( o \vert π )} [ log ( P ( o ) ]}}_{Pragmatic value} - {\underbrace{{𝔼}_{Q ( s , o \vert π )} {D}_{KL} [ Q ( s \vert o , π ) ‖ Q ( s \vert π ) ]}}_{Epistemic value}$$

where π=a_{1:H} is a trajectory, E denotes expectations, s=s_{1:H} and o=o_{1:H} are sequences of future states and observations up to a planning time horizon H. Q(s|π) and Q(o|s,π) are an agent's prior and posterior beliefs about future states, respectively. The beliefs can be propagated forward in time from the current belief based on a state transition model.

The pragmatic value can be defined based on a prior probability distribution over observations and can be biased such that observations preferred by the agent have the highest probability and the highest pragmatic value. The preferences P(o) define the observations that the agent seeks to achieve through action, such as maintaining a speed near the speed limit.

The epistemic value can be defined as an expected divergence between the agent's prior and posterior beliefs about external states associated with the trajectory, which can correspond to expected Bayesian Surprise. The epistemic value can thus be maximized for observations that lead to a maximum change in beliefs. The epistemic value can also be expressed as the difference between the posterior predictive entropy and the expected ambiguity. In uncertain situations, minimizing expected free energy promotes policies with high epistemic value. Bayesian Surprise is described in more detail in commonly owned U.S. patent application Ser. No. 17/399,418, filed Aug. 11, 2021, and entitled, “ASSESSING SURPRISE FOR AUTONOMOUS VEHICLES,” and which is herein incorporated by reference. Active inference models are described in more detail in commonly owned U.S. application Ser. No. 18/614,428, filed Mar. 22, 2024, and entitled “ASSESSING DRIVING PLANS FOR AUTONOMOUS VEHICLES”; and U.S. Application No. 63/454,012, filed Mar. 22, 2023, and entitled “ASSESSING DRIVING PLANS FOR AUTONOMOUS VEHICLES,” which are herein incorporated by reference.

After determining the EFE for each candidate policy or trajectory, the action for the next timestep can be sampled from a distribution of the first actions in the trajectories with the lowest EFEs. The system can then execute the action, and the current state changes. In a real-world driving scenario, the system can for example manipulate control mechanisms of the vehicle to cause the vehicle to follow the sampled trajectory.

The system can use a generative model which includes a state transition distribution and an observation distribution to obtain new observations. The agent's beliefs are updated into posterior beliefs based on the new observations. For example, the system can update beliefs by minimizing the variational free energy of the generative model.

The generative model is a statistical model of how states in the world generate observations. The generative model predicts the future behavior of other agents, and also how the agent's own actions (e.g., accelerating, steering, braking) affect future observations including the behavior of other agents. For example, the generative model can be represented as a discrete-time Partially Observable Markov Decision Process (POMDP) which describes how environment states, such as the state of the agent, evolve over time, depending on the agent's chosen trajectories and resulting actions. The generative model also generates signals observed by the agent, or observations, such as the presence of another agent.

Under active inference, “excitatory” goals, such as making progress towards the destination and “inhibitory” factors, such as avoiding hard braking, collisions, and road departures, are generally represented in terms of preferred observations or states. For a road user agent, this preferred observation/state may conceptually be characterized as “I'm making safe progress towards the destination while avoiding harmful events and respecting rules of the road and other social norms”. According to active inference, the agent's behavior can then be explained by the mandate to generate observations that confirm this preferred state, which is equivalent to maximizing the evidence for its generative model or minimizing surprise.

The active inference model 134 can compute pragmatic values for either the vehicle itself 122 or other agents in the environment. When used for other agents in the environment, such pragmatic values 165 can also be used to predict the behaviors of the other agents using an evidence accumulation process.

In general, evidence accumulation can be used to determine when another entity in the agent environment does something inconsistent with the agent's expectations, at which point such onset of the unexpected condition can trigger the selection of a new driving policy.

The active inference model 134 and agent behavior model 138 can be generated by the training system 110, which can be implemented in a datacenter 112. A training subsystem 114 can implement distributed training operations over thousands of nodes for various machine learning models, and can include all the trainable elements of the models that impact the planning subsystem 136 of the AV, including the active inference model 134 and the agent behavior model 138. The training subsystem 114 includes a plurality of computing devices having software or hardware modules that implement the respective training operations. More specifically, the training subsystem 114 can use a collection of trajectory training data 125 representing traffic scenarios to train the models that impact the planning subsystem 126. In some implementations, the training data 125 is collected by sensors on the vehicle 122 or another autonomous vehicle. The training data 125 can take a variety of forms depending on which type of traffic scenario the trajectories come from, but properties of agents are generally maintained across each of multiple time steps within each scenario. In some implementations, the training data 125 for each traffic scenario can be labeled to indicate the presence or absence of particular features of agents in the environment and which type of traffic scenario was involved. The training subsystem 114 can be configured to train the pragmatic value module 142 and epistemic value module 140 of the active inference model 134, and more sophisticated versions thereof, using the training data 125. After training is complete, the training system 110 can then provide a final set of model parameter values 171 by a wired or wireless connection to the on-board system 120.

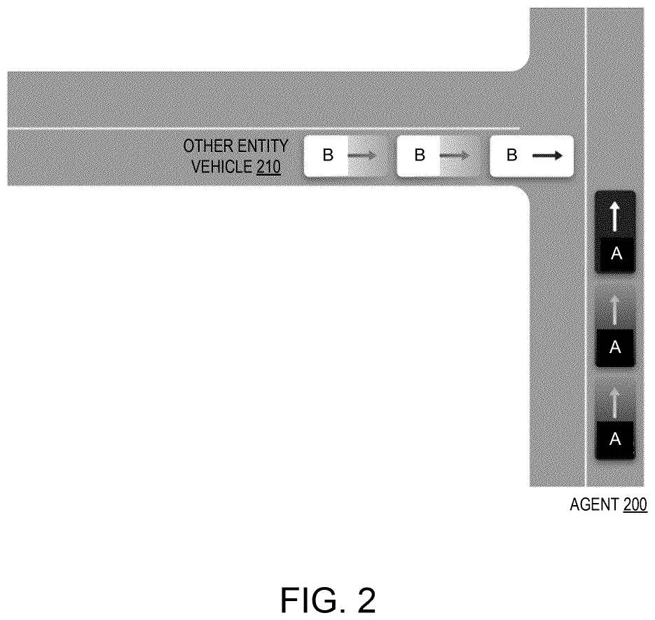

FIG. 2 depicts an example traffic scenario of an agent and another entity vehicle approaching an intersection in an interaction that illustrates the main challenges inherent to measuring and modeling agent driving behavior in real-life scenarios. In this interaction, at time T1 an agent 200 (vehicle A) is driving on a main road with the right of way. Meanwhile, an other entity vehicle 210 (vehicle B) approaches at constant speed on a perpendicular road that intersects the main road. This is an example of a gradually evolving traffic scenario without a physically well-defined stimulus onset.

In an example scenario, vehicle B 210 starts slowing down to yield at the intersection point, as is expected. The agent 200 driver notices this and keeps driving on the main road. Since the agent 200 driver does not need to act, this is a largely unsurprising situation that does not require the selection of a new driving policy.

In another example scenario, vehicle B 210 does not start slowing down and continues approaching the intersection at constant speed such that immediate action is needed to avoid a collision. Instead of yielding, as would be expected since the agent 200 has the right of way, vehicle B 210 continues at constant speed and enters in front of the agent vehicle 200. In this case, the agent 200 driver notices that something is awry at some point but may or may not have time to react in time and perform an evasive maneuver before the impending collision. In this case, vehicle B 210 was visible to the agent 200 driver long before the scenario turned critical, but it is not immediately clear at what point during vehicle B's 210 approach to the intersection to set the stimulus onset.

Unlike carefully controlled experiments to calculate response time in a laboratory, the ambiguity of stimulus onset is a reality in real-world situations where situations evolve gradually and agents do not behave based on instructions. In addition, agent behavior is highly situation-dependent: decisions in real-life scenarios correlate strongly with the urgency of the scenario, i.e., there cannot be a notion of a constant response time across all traffic scenarios. As an example, the selection of a policy needed to perform an evasive maneuver to avoid a collision in a lead vehicle braking scenario on a highway happens much quicker if the responding (following) driver is initially just behind the braking lead vehicle compared to when it is further away, the general reason being that the evidence that a collision is imminent, and a new policy is needed, accumulates faster in the former case.

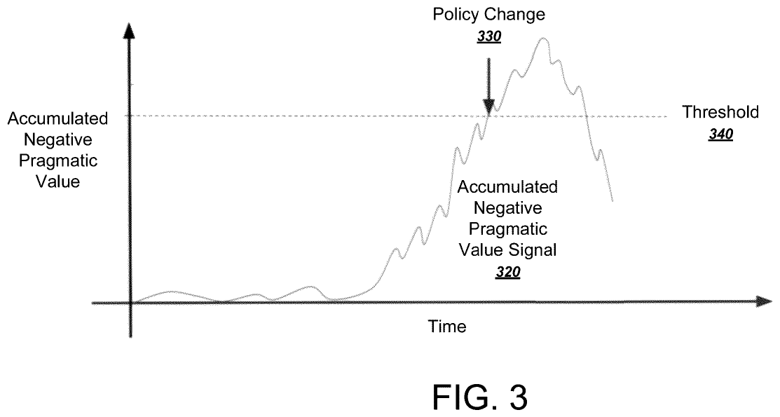

FIG. 3 is a diagram of an example framework for modeling agent decisions in real-world scenarios. The framework conceptualizes an agent's response to a traffic scenario as an active inference process, specifically an inference process where the agent's behavior is guided by a goal preference for a particular control policy. The pragmatic value of a current trajectory thus represents how much closer the agent will get toward the goal preference.

As the situation evolves, sensory input is updated and continually processed in order to recompute pragmatic values. If the sensory input remains consistent with the goal preference, the pragmatic value of the currently selected policy will be high and the agent will continue using this control policy.

However, if the sensory input becomes increasingly inconsistent with the agent's goal preference, the pragmatic value is reduced and, conversely, the accumulated negative pragmatic value signal 320 (representing deviations from the preferred value) increases. At a certain point, the accumulated negative pragmatic value signal 320 crosses a threshold 340. At that point, the agent perform a policy change 330 in order to initiate another action, e.g., an evasive maneuver, braking, or swerving, to name just a few examples. For example, the agent can perform the policy change 330 by performing a full policy update. A full policy update can include selecting a new control policy that is different from the currently selected policy and implementing the new control policy.

In some implementations, if the accumulated negative pragmatic value signal 320 does not cross the threshold 340, the agent can still update the policy by updating a last action in the policy at every timestep. For example, a policy can include a sequence of multiple actions that are performed over multiple timesteps. At each of the multiple timesteps, the agent can update the policy to add one or more additional actions to the sequence of multiple actions. For example, if an agent has performed one action of the multiple actions included in the policy at a given timestep, the agent can update the policy at the given timestep by one additional action as the last action to be performed in the sequence of multiple actions.

Notably, modeling agent decision making in this way does not allow the agent to instantaneously change to a new policy whenever the pragmatic value 310 drops. Instead, the accumulation of pragmatic values provides for a more realistic model of human driving behavior.

These techniques can further be enhanced by considering looming. In the vehicular navigation context, looming refers to the rate of change of the visual angle subtended by an object from an observer's point of view, where the visual angle may change e.g., due to getting closer to an object. For example, looming can be measured based on an angle subtended by a lead vehicle on a sensor or a simulated retina of the modeled agent. The system can enhance the modeling of human driving behavior by using looming as an onset threshold before starting to accumulate pragmatic values. In other words, once the looming value has reached a particular looming value threshold representing the perceptual detection threshold of a human driver, the system can start the accumulation of pragmatic values. This approach more realistically models the limits of human perception as well as its effect on the time required to respond to a traffic conflict.

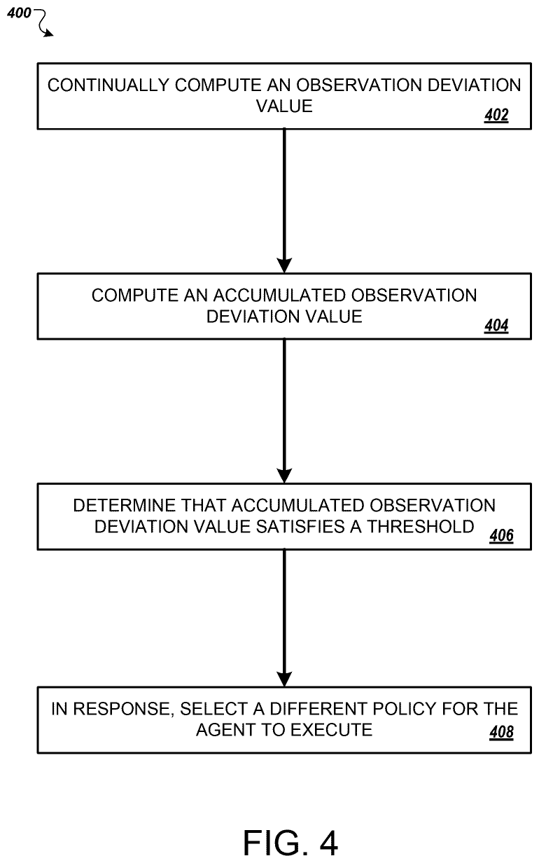

FIG. 4 is a flow diagram of an example process 400 for selecting a driving policy for an agent to execute. For convenience, the process 400 will be described as being performed by a system of one or more computers located in one or more locations. For example, an on-board system, e.g., the on-board system 120 of FIG. 1, appropriately programmed in accordance with this specification, can perform the process 400.

The system continually computes, at each time step of a plurality of time steps, an observation deviation value for a current driving policy of an agent (402). In some implementations, the observation deviation value represents a difference between a goal of the current driving policy and a state of the agent based on one or more observations of an environment of the agent. In some implementations, the observation deviation value of a policy represents a degree to which the agent will advance toward a goal.

At each time step, the observation deviation value can be computed as a component of the expected free energy value of an active inference modeling framework. As described above, the expected free energy can be based on a pragmatic value that value is defined based on a prior probability distribution over observations and is biased such that observations preferred by the agent have the highest probability and the highest pragmatic value. The expected free energy value can be further based on an epistemic value that represents a potential reduction in uncertainty for the current driving policy. For example, the expected free energy can be computed as a negative sum of a pragmatic value and an epistemic value, e.g., according to the equation described above with reference to FIG. 1.

The system computes an accumulated observation deviation value including accumulating observation deviation values computed for each of a plurality of time steps (404). In some implementations, computing the accumulated observation deviation value includes accumulating observation deviation values over a particular time window that includes the plurality of time steps. In some implementations, accumulating the observation deviation values includes accumulating pragmatic values, which can be negative pragmatic values. For example, as described above, sensory input to the system can be continually processed in order to continually recompute pragmatic values. The pragmatic values within a time window can be accumulated, e.g., via the computation of an accumulated negative pragmatic value.

The system determines that an accumulated observation deviation value satisfies a threshold (406). For example, the accumulated observation deviation value can be the accumulated negative pragmatic value 320 of FIG. 3, and the threshold can be the threshold 340 of FIG. 3. The determination can include a determination that the accumulated negative pragmatic value crosses the threshold, as described with reference to FIG. 3.

In response to determining that an accumulated observation deviation value satisfies a threshold, the system can select a different policy for the agent to execute after the accumulated observation deviation value satisfies the threshold (408). For example, as described above, the system can perform a policy change, such as the policy change 330 of FIG. 3, to start another action. The other action can be, for example, an evasive maneuver, braking, or swerving.

In some implementations, the process 400 can also include operations of continually computing a looming value relative to another road user, and selecting a new policy after the looming value satisfies a threshold. For example, as described above, the system can use looming as an onset threshold before starting to accumulate observation deviation values, e.g., pragmatic values. Once the continually-computed looming value has reached a particular looming value threshold representing the perceptual detection threshold of a human driver, the system can start the accumulation of pragmatic values.

Certain novel aspects of the subject matter of this specification are set forth in the claims below, accompanied by further description in Appendix A and Appendix B.

The term “data processing apparatus” refers to data processing hardware and encompasses all kinds of apparatus, devices, and machines for processing data, including by way of example a programmable processor, a computer, or multiple processors or computers. The apparatus can also be, or further include, off-the-shelf or custom-made parallel processing subsystems, e.g., a GPU or another kind of special-purpose processing subsystem. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

1. A computer-implemented method comprising:
continually computing, at each time step of a plurality of time steps, an observation deviation value for a current driving policy of an agent;
computing an accumulated observation deviation value including accumulating observation deviation values computed for each of a plurality of time steps;
determining that an accumulated observation deviation value satisfies a threshold; and
in response, selecting a different policy for the agent to execute after the accumulated observation deviation value satisfies the threshold.

2. The method of claim 1, wherein the observation deviation value represents a difference between a goal of the current driving policy and a state of the agent based on one or more observations of an environment of the agent.

3. The method of claim 1, wherein the observation deviation value of a policy represents a degree to which the agent will advance toward a goal.

4. The method of claim 1, wherein computing the accumulated observation deviation value comprises accumulating observation deviation values over a particular time window that includes the plurality of time steps.

5. The method of claim 2, wherein the observation deviation value is computed as a component of the expected free energy value of an active inference modeling framework.

6. The method of claim 5, wherein the expected free energy value is further based on an epistemic value that represents a potential reduction in uncertainty for the current driving policy.

7. The method of claim 1, further comprising:
continually computing a looming value relative to another road user or object on the road; and
selecting a new policy after the looming value satisfies a threshold.

8. The method of claim 1, wherein accumulating the observation deviation values comprises accumulating pragmatic values.

9. The method of claim 8, wherein accumulating the pragmatic values comprises accumulating negative pragmatic values.

10. A system comprising: one or more computers and one or more storage devices storing instructions that are operable, when executed by the one or more computers, to cause the one or more computers to perform operations comprising:
continually computing, at each time step of a plurality of time steps, an observation deviation value for a current driving policy of an agent;
computing an accumulated observation deviation value including accumulating observation deviation values computed for each of a plurality of time steps;
determining that an accumulated observation deviation value satisfies a threshold; and
in response, selecting a different policy for the agent to execute after the accumulated observation deviation value satisfies the threshold.

11. The system of claim 10, wherein the observation deviation value represents a difference between a goal of the current driving policy and a state of the agent based on one or more observations of an environment of the agent.

12. The system of claim 10, wherein the observation deviation value of a policy represents a degree to which the agent will advance toward a goal.

13. The system of claim 10, wherein computing the accumulated observation deviation value comprises accumulating observation deviation values over a particular time window that includes the plurality of time steps.

14. The system of claim 11, wherein the observation deviation value is computed as a component of the expected free energy value of an active inference modeling framework.

15. The system of claim 14, wherein the expected free energy value is further based on an epistemic value that represents a potential reduction in uncertainty for the current driving policy.

16. The system of claim 10, wherein the operations further comprise:
continually computing a looming value relative to another road user; and
selecting a new policy after the looming value satisfies a threshold.

17. The system of claim 10, wherein accumulating the observation deviation values comprises accumulating pragmatic values.

18. The system of claim 17, wherein accumulating the pragmatic values comprises accumulating negative pragmatic values.

19. A computer storage medium encoded with a computer program, the program comprising instructions that are operable, when executed by data processing apparatus, to cause the data processing apparatus to perform operations comprising:
continually computing, at each time step of a plurality of time steps, an observation deviation value for a current driving policy of an agent;
computing an accumulated observation deviation value including accumulating observation deviation values computed for each of a plurality of time steps;
determining that an accumulated observation deviation value satisfies a threshold; and
in response, selecting a different policy for the agent to execute after the accumulated observation deviation value satisfies the threshold.

20. The computer storage medium of claim 19, wherein the observation deviation value represents a difference between a goal of the current driving policy and a state of the agent based on one or more observations of an environment of the agent.
